(19) United States
(12) Patent Application Publication
(10) Pub. No.: US 2019/0041676 A1
(43) Pub. Date: Feb. 7, 2019

(54) A LCD PANEL AND A DRIVING CIRCUIT FOR THE LCD PANEL

(71) Applicant: Wuhan China Star Optoelectronics Technology Co., Ltd., Wuhan, Hubei (CN)

(72) Inventor: Zhenzhou XING, Shenzhen, Guangdong (CN)

(73) Assignee: Wuhan China Star Optoelectronics Technology Co., Ltd., Wuhan, Hubei (CN)

(21) Appl. No.: 15/560,122

(22) PCT Filed: Aug. 22, 2017
(86) PCT No.: PCT/CN2017/098453

§ 371 Date: Sep. 20, 2017

(30) Foreign Application Priority Data
Aug. 2, 2017 (CN) 201710655270.X

(51) Int. Cl. G02F 1/133; G02F 1/1345; G09G 3/36

(52) U.S. Cl. CPC G02F 1/13306; G02F 1/13452; G09G 2310/0264; G09G 2300/0804; G09G 3/3648

(57) ABSTRACT

The present invention discloses a LCD panel and a driving circuit for the LCD panel. The LCD panel comprises a source driving chip and a plurality of multiplexing circuits; wherein the source driving chip is used to provide a plurality of source driving signals, each of the multiplexing circuits used to receive one of the source driving signals and a plurality of control signals, and the multiplexing circuit controlled by the control signals to transmit one of the multiple source driving signals in time-division into a plurality of pixels corresponding to one of the source driving signals. In the above-described manner, the present invention can reduce the number of control signals and reduce the area of the signal traces that carry the control signals on the frame of the liquid crystal panel, so reduce the frame width of the LCD panel and achieve the narrow frame design.

### FIELD OF THE DISCLOSURE

Aspects of the present invention relate to LCD panel technology field, especially related to a LCD panel and a driving circuit for the LCD panel.

### BACKGROUND

With the rapid development of liquid crystal display technology, LTPS (Low Temperature Poly-silicon) has gradually replaced a-Si (amorphous silicon) by the advantage of high carrier mobility. In order to meet the market demand for high resolution of the LCD panel, LCD panel driving circuit introduced a multiplexing drive architecture which drives multiple pixels by a source driving signal.

In the prior art, in order to realize a source driving signal driving a plurality of pixels, it is necessary to introduce a plurality of control signals and a plurality of transistors, wherein the gates of the plurality of transistors receive the plurality of control signals, the drains of the plurality of transistors connect each other to receive a source driving signal, and the sources of plurality of transistors connect with a plurality of pixels. Wherein, the amount of the plurality of control signals and the amount of the plurality of pixels are the same.

In a case of driving the six pixels by one of the source driving signals, for example, the driver circuit needs six control signals and six transistors. As a result of the introduction of six control signals, the frame of the LCD panel needs six signal traces to carry six control signals; wherein six transistors are disposed on the six signal lines. As the six signal traces on the frame of the LCD panel occupied a larger area, so it is harmful to realize a narrow LCD frame.

### SUMMARY

To solve above technical problem, the present invention mainly discloses a LCD panel and a driving circuit for the LCD panel, so the frame width of the liquid crystal panel can be reduced and the narrow frame design can be realized.

In order to solve the above technical problem, an embodiment adopted by the present invention provides a driving circuit for a LCD panel, which comprising a pixel-array arranged in a matrix, comprising, a source driving chip and a plurality of multiplexing circuits; wherein the source driving chip is used to provide a plurality of source driving signals, each of the multiplexing circuits used to receive one of the source driving signals and a plurality of control signals, and the multiplexing circuit controlled by the control signals to transmit one of the multiple source driving signals in time-division into a plurality of pixels corresponding to one of the source driving signals; wherein the amount of the control signals is less than the amount of the pixels corresponding to the one of the source driving signals; wherein the source driving chip comprises a plurality of source signal output terminals; each of the multiplexing circuits comprising an input terminal, a plurality of control terminals, and a plurality of output terminals; one of the source signal output terminals connects the input terminal of the multiplexing circuit; the plurality of the control terminals of the multiplexing circuits receive the plurality of the control signals separately; and the plurality of the output terminals of the multiplexing circuits connect the plurality of the pixels on the pixel-array separately; and wherein the pixel array comprises a plurality of pixel-rows arranged in a column direction, each pixel row comprises the plurality of pixels with different colors arranged cyclically in a row direction.

In order to solve the above technical problem, another embodiment adopted by the present invention provides: a driving circuit for a LCD panel, which comprising a pixel-array arranged in a matrix, comprising, a source driving chip and a plurality of multiplexing circuits; wherein the source driving chip is used to provide a plurality of source driving signals, each of the multiplexing circuits used to receive one of the source driving signals and a plurality of control signals, and the multiplexing circuit controlled by the control signals to transmit one of the multiple source driving signals in time-division into a plurality of pixels corresponding to one of the source driving signals; and wherein the amount of the control signals is less than the amount of the pixels corresponding to the one of the source driving signals.

In order to solve the above technical problem, another embodiment adopted by the present invention provides: a LCD panel, comprising a driving circuit and a pixel-array arranged in a matrix; where the driving circuit comprising a source driving chip and a plurality of multiplexing circuits; wherein the source driving chip is used to provide a plurality of source driving signals, each of the multiplexing circuits used to receive one of the source driving signals and a plurality of control signals, and the multiplexing circuit controlled by the control signals to transmit one of the multiple source driving signals in time-division into a plurality of pixels corresponding to one of the source driving signals; wherein the amount of the control signals is less than the amount of the pixels corresponding to the one of the source driving signals.

The advantageous effect of the present invention is that, unlike the case of the prior art, the LCD panel and the driving circuit for the LCD panel of the present invention introduced a multiplexing circuit, wherein each of the multiplexing circuits used to receive one of the source driving signals and a plurality of control signals, and the multiplexing circuit controlled by the control signals to transmit one of the multiple source driving signals in time-division into a plurality of pixels corresponding to one of the source driving signals. In the above-described manner, the present invention can reduce the number of control signals and reduce the area of the signal traces that carry the control signals on the frame of the liquid crystal panel, so reduce the frame width of the LCD panel and achieve the narrow frame design.

### BRIEF DESCRIPTION OF THE DRAWINGS

FIG. 1 is a schematic diagram of a LCD panel in the present invention;

FIG. 2 is a circuit schematic diagram of the multiplexing circuit of the LCD panel of FIG. 1;

FIG. 3 is a circuit schematic diagram of an embodiment of the multiplexing circuit of FIG. 2;

FIG. 4 is an operation timing diagram of the multiplexing circuit of FIG. 3; and

FIG. 5 is a partial space diagram of the LCD panel of FIG. 1.

### DETAILED DESCRIPTION OF PREFERRED EMBODIMENTS

The embodiments are described below in order to explain the present invention by referring to the figures.

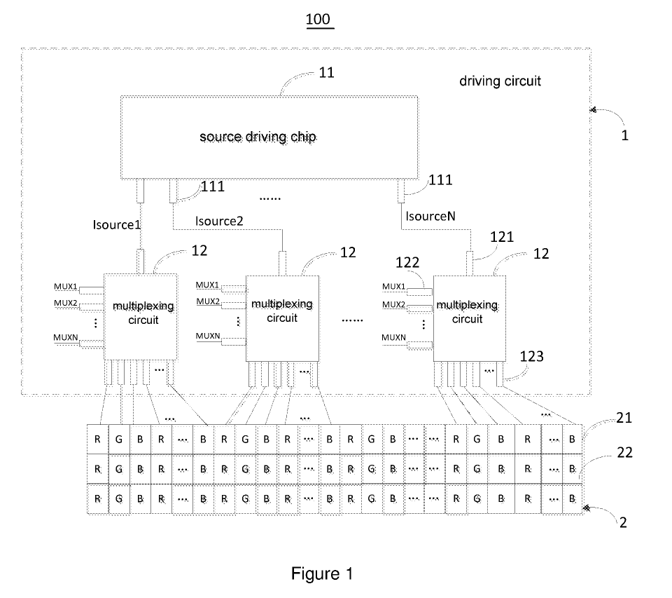

Referring to FIG. 1, the schematic diagram of a LCD panel in the present invention, a LCD panel 100 comprises a driving circuit 1 and a pixel-array 2 arranged in a matrix, wherein the driving circuit 1 used for driving the pixel-array 2.

The pixel-array 2 comprises a plurality of pixel-rows 21 arranged in a column direction, each pixel row comprises the plurality of pixels 22 with different colors arranged cyclically in a row direction. In a better embodiment, each of said pixel rows 21 comprises a plurality of pixels 22 arranged cyclically in accordance with red pixels R, green pixels G, and blue pixels B in a row direction.

The driving circuit 1 comprises a source driving chip 11 and a plurality of multiplexing circuits 12, wherein the source driving chip 11 is used to provide a plurality of source driving signals IsourceN (N is a natural number), each of the multiplexing circuits 12 used to receive one of the source driving signals IsourceN and a plurality of control signals MUXN (N is a natural number), and the multiplexing circuit controlled by the control signals MUXN to transmit one of the multiple source driving signals IsourceN in time-division into a plurality of pixels 22 corresponding to one of the source driving signals IsourceN on the pixel-array 2, wherein the amount of the control signals MUXN is less than the amount of the pixels 22 corresponding to the one of the source driving signals IsourceN.

Specifically, the source driving chip 11 comprises a plurality of source signal output terminals 111; each of the multiplexing circuits 12 comprising an input terminal 121, a plurality of control terminals 122, and a plurality of output terminals 123; one of the source signal output terminals 111 of the source driving chip 11 connects the input terminal 121 of the multiplexing circuit 12; the plurality of the control terminals 122 of the multiplexing circuits 12 receive the plurality of the control signals MUXN separately; and the plurality of the output terminals 123 of the multiplexing circuits 12 connect the plurality of the pixels 22 on the pixel-array 2 separately.

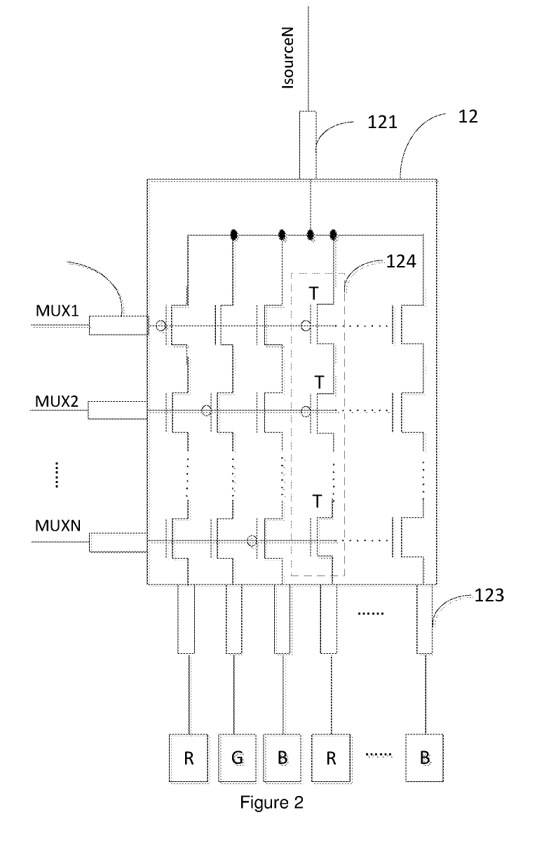

Referring to FIG. 2, the circuit schematic diagram of the multiplexing circuit of the LCD panel of FIG. 1, each of the multiplexing circuits 12 comprises an input terminal 121, a plurality of control terminals 122, and a plurality of output terminals 123; wherein the amount of the plurality of the control terminals is N and the amount of the plurality of output terminals is B; wherein the multiplexing circuit 12 further comprising B transistor-columns 124, and each transistor-column comprising N transistors T.

The gates of the N transistors in each transistor-column 124 connect to the N control terminals 122 respectively to receive N control signals MUX1, MUX2, . . . MUXN, and the sources and the drains of the N transistors connect the input terminals 121 and the output terminals 122 respectively.

In the present embodiment, the types of the transistor T comprise an NMOS transistor and a PMOS transistor, and the N-type transistor T of the B transistor columns 204 arranged in a different order. For example, assuming that N is 3, the order of the three transistors T in the first transistor-column 124 is the NMOS transistor, the PMOS transistor, the PMOS transistor respectively; and the order of the three transistors T in the second transistor-column 124 is the PMOS transistor, NMOS transistor, PMOS transistor; thus, the order of the two types are different from each other.

It will be understood by those skilled in the art that the order of the type of transistor T shown in FIG. 2 is one embodiment only and the present invention is not limited thereto.

In a better embodiment, the amount of the plurality of the control terminals is N and the amount of the plurality of output terminals is B, the value range of B is greater than N and is less than or equal to 2 of the N power. Taking the number N of the control terminals 122 is three as an example, the number of output terminals 123 can be 4, 5, 6, 7 or 8; in other words, when the number of control signals received by the control terminal 122 is three, one source driving signal IsourceN can drive four, five, six, seven or eight pixels 22.

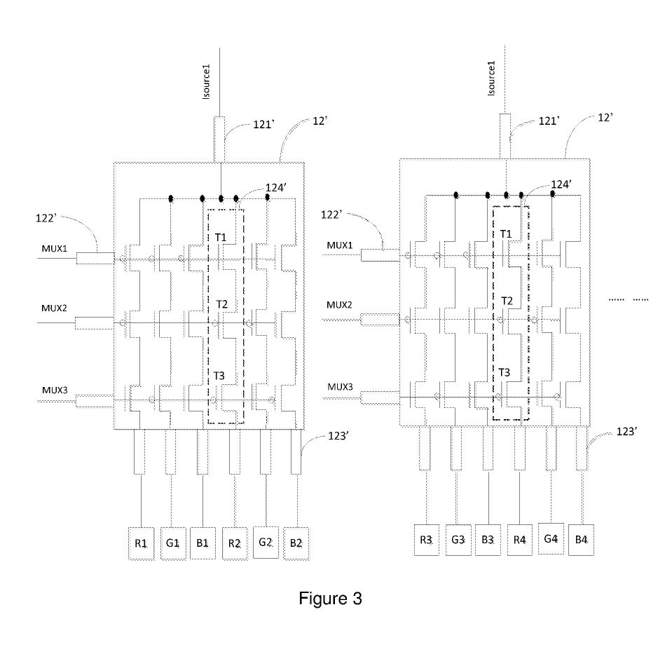

Referring to FIG. 3, the circuit schematic diagram of an embodiment of the multiplexing circuit of FIG. 2, each of said multiplexing circuits 12′ comprises an input terminal 121′, three control terminals 122′, six output terminals 123′ and six transistor-columns 124′; each transistor-columns 124′ comprising three transistors, denoted as a first transistor T1, a second transistor T2 and a third transistor T3, respectively; the plurality of control signals MUXN comprising a first control signal MUX1, a second control signal MUX2 and a third control signal MUX3.

The gates of the three transistors 124′ of each the transistor-column connect three control terminals 122′ respectively to correspondingly receive the first control signal MUX1, the second control signal MUX2 and the third control signal MUX3; in other words, the gate of the first transistor T1 of each transistor-column 124′ receives the first control signal MUX1, the gate of the second transistor T2 receives the second control signal MUX2, and the gate of the third transistor T3 receives the third control signal MUX3.

The drain of the first transistor T1 of each transistor column 124′ connects the input terminal 121′ to receive one of the source driving signals IsourceN, the source of the first transistor T1 of each transistor column 124′ connects the drain of the second transistor T2, the source of the second transistor T2 connects the drain of the third transistor T3, and the source of the third transistor T3 connects one of the output terminals 123′ to transmit the source driving signal IsourceN to the pixels 22 corresponding to the output terminals.

In the present embodiment, the first transistor T1, the second transistor T2 and the third transistor T3 of the first transistor-column 124′ are NMOS transistors, NMOS transistors, PMOS transistors; the first transistor T1, the second transistor T2 and the third transistor T3 of the second transistor-column 124′ are NMOS transistors, PMOS transistors, NMOS transistors; the first transistor T1, the second transistor T2 and the third transistor T3 of the third transistor-column 124′ are NMOS transistors, PMOS transistors, PMOS transistors; the first transistor T1, the second transistor T2 and the third transistor T3 of the fourth transistor-column 124′ are PMOS transistors, NMOS transistors, NMOS transistors; the first transistor T1, the second transistor T2 and the third transistor T3 of the fifth transistor-column 124′ are PMOS transistors, NMOS transistors, PMOS transistors; and the first transistor T1, the second transistor T2 and the third transistor T3 of the sixth transistor-column 124′ are PMOS transistors, PMOS transistors, NMOS transistors.

In the present embodiment, taking the pixel row 21 as an example, each of the multiplexing circuits 12′ controls the six pixel units 22. Specifically, the first multiplexing circuit 12′ controls the first red pixel R1, the first green pixel G1, the first blue pixel B1, the second red pixel R2, the second green pixel G2, and the second blue pixel B2; the second multiplexer circuit 12′ controls the third red pixel R3, the third green pixel G3, the third blue pixel B3, the fourth red pixel R4, the fourth green pixel G4, the fourth blue pixel B4, . . . so on and so forth.

The first control signal MUX1, the second control signal MUX2 and the third control signal MUX3 cooperate with each other in a scan cycle to control the six transistor columns 124′ to be sequentially turned on, so one source driving signal IsourceN is transmitted to the corresponding six pixels in time-divisions.

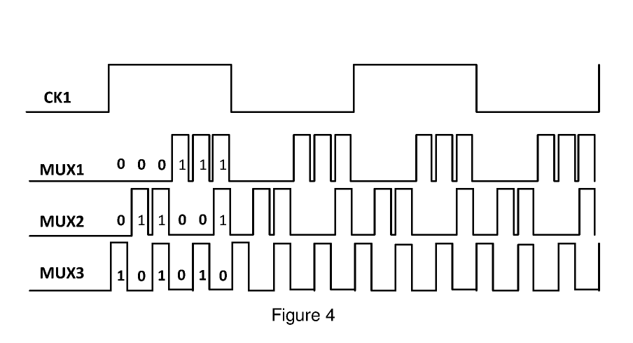

Referring to FIG. 4, the operation timing diagram of the multiplexing circuit of FIG. 3, and taking the first multiplexing circuit 12′ as an example, in the scan period CK1, when the first control signal MUX1 is in a low voltage level (i.e., 0), the second control signal MUX2 is in a low voltage level, and the third control signal MUX3 is in a high voltage level (i.e., 1), the first transistor T1, the second transistor T2, and the third transistor T3 of the first transistor column 124′ are turned on, and the source driving signal Isource1 is transmitted to the first red pixel R1; when the first control signal MUX1 is in a low voltage level, the second control signal MUX2 is in a high voltage level, and the third control signal MUX3 is in a low voltage level, the first transistor T1, the second transistor T2, and the third transistor T3 of the second transistor column 124′ are turned on, and the source driving signalIsource1 is transmitted to the first green pixel G1; when the first control signal MUX1 is in a low voltage level, the second control signal MUX2 is in a high voltage level, and the third control signal MUX3 is in a high voltage level, the first transistor T1, the second transistor T2, and the third transistor T3 of the third transistor column 124′ are turned on, and the source driving signal Isource1 is transmitted to the first blue pixel B1; when the first control signal MUX1 is in a high voltage level, the second control signal MUX2 is in a low voltage level, and the third control signal MUX3 is in a low voltage level, the first transistor T1, the second transistor T2, and the third transistor T3 of the fourth transistor column 124′ are turned on, and the source driving signal Isource1 is transmitted to the second red pixel R2; when the first control signal MUX1 is in a high voltage level, the second control signal MUX2 is in a low voltage level, and the third control signal MUX3 is in a high voltage level, the first transistor T1, the second transistor T2, and the third transistor T3 of the fifth transistor column 124′ are turned on, and the source driving signal Isource1 is transmitted to the second green pixel G2; and when the first control signal MUX1 is in a high voltage level, the second control signal MUX2 is in a high voltage level, and the third control signal MUX3 is in a low voltage level, the first transistor T1, the second transistor T2, and the third transistor T3 of the sixth transistor column 124′ are turned on, and the source driving signal Isource1 is transmitted to the second blue pixel B2. In other words, showed as the Table 1, in a scan cycle, the first control signal MUX1 is in a low voltage level (i.e., 0), a low voltage level, a low voltage level, a high voltage level (i.e., 1), a high voltage level, and a high voltage level in time-division; the second control signal is in a low voltage level, a high voltage level, a high voltage level, a low voltage level, a low voltage level, and a high voltage level in time-division; and the third control signal is in a high voltage level, a low voltage level, a high voltage level, a low voltage level, a high voltage level, and a low voltage level in time-division; one of the source driving signals Isource1transmits in time-division to the six pixels i.e., the first red pixel R1, the first green pixel G1, the first blue pixel B1, the second red pixel R2, the second Green pixel G2, second blue pixel B2.

TABLE 1

Isource 1

| | | | | | | |
|---|---|---|---|---|---|---|
| MUX1 | 0 | 0 | 0 | 1 | 1 | 1 |
| MUX2 | 0 | 1 | 1 | 0 | 0 | 1 |
| MUX3 | 1 | 0 | 1 | 0 | 1 | 0 |
| Pixel unit | R1 | G1 | B1 | R2 | G2 | B2 |

In the present embodiment, the operation principles of the first multiplexing circuit 12′ the other multiplexing circuits 12′ are the same, so it will not be described again for simplicity.

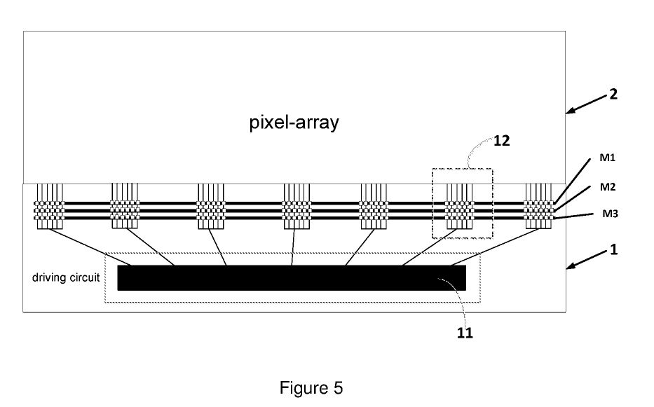

Referring to FIG. 5, the partial space diagram of the LCD panel of FIG. 1, on the LCD panel of the FIG. 5, the signal traces M1, M2 and M3 are used for transmitting the first control signal MUX1, the second control signal line MUX2 and the third control signal MUX3; and the transistors T of the multiplexing circuit 12 are arranged in matrix on the signal lines M1, M2 and M3; wherein the signal lines M1, M2 and M3 are arranged on the frame of the liquid crystal panel.

In contrast to the prior art, taking the driving six pixels by one source driving signal as an example, since only three control signals, i.e., three signal traces, are required in the present invention to drive six pixels by one source driving signal, and the prior art requires six control signals, i.e. six signal traces, to drive six pixels by one source driving signal; so, the present invention can reduce the number of control signals and reduce the area of the signal traces that carry the control signals on the frame of the liquid crystal panel, so reduce the frame width of the LCD panel and achieve the narrow frame design.

The advantageous effect of the present invention is that, unlike the case of the prior art, the LCD panel and the driving circuit for the LCD panel of the present invention introduced a multiplexing circuit, wherein each of the multiplexing circuits used to receive one of the source driving signals and a plurality of control signals, and the multiplexing circuit controlled by the control signals to transmit one of the multiple source driving signals in time-division into a plurality of pixels corresponding to one of the source driving signals. In the above-described manner, the present invention can reduce the number of control signals and reduce the area of the signal traces that carry the control signals on the frame of the liquid crystal panel, so reduce the frame width of the LCD panel and achieve the narrow frame design.

Although a few embodiments of the present invention have been shown and described, it would be appreciated by those skilled in the art that changes may be made in this embodiment without departing from the principles and spirit of the invention, the scope of which is defined in the claims and their equivalents.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claim is:

1. A driving circuit for a LCD panel, which comprises a pixel-array arranged in a matrix, comprising,
a source driving chip and a plurality of multiplexing circuits;
wherein the source driving chip is used to provide a plurality of source driving signals, each of the multiplexing circuits used to receive one of the source driving signals and a plurality of control signals, and the multiplexing circuit controlled by the control signals to transmit one of the multiple source driving signals in time-division into a plurality of pixels corresponding to one of the source driving signals;
wherein the amount of the control signals is less than the amount of the pixels corresponding to the one of the source driving signals;
wherein the source driving chip comprises a plurality of source signal output terminals; each of the multiplexing circuits comprising an input terminal, a plurality of control terminals, and a plurality of output terminals; one of the source signal output terminals connects the input terminal of the multiplexing circuit; the plurality of the control terminals of the multiplexing circuits receive the plurality of the control signals separately; and the plurality of the output terminals of the multiplexing circuits connect the plurality of the pixels on the pixel-array separately; and
wherein the pixel array comprises a plurality of pixel-rows arranged in a column direction, each pixel row comprises the plurality of pixels with different colors arranged cyclically in a row direction.

2. The driving circuit of claim 1, wherein the amount of the plurality of the control terminals is N and the amount of the plurality of output terminals is B, the value range of B is greater than N and is less than or equal to 2 of the N power.

3. A driving circuit for a LCD panel, which comprising a pixel-array arranged in a matrix, comprising,
a source driving chip and a plurality of multiplexing circuits;
wherein the source driving chip is used to provide a plurality of source driving signals, each of the multiplexing circuits used to receive one of the source driving signals and a plurality of control signals, and the multiplexing circuit controlled by the control signals to transmit one of the multiple source driving signals in time-division into a plurality of pixels corresponding to one of the source driving signals; and
wherein the amount of the control signals is less than the amount of the pixels corresponding to the one of the source driving signals.

4. The driving circuit of claim 3, wherein the source driving chip comprises a plurality of source signal output terminals; each of the multiplexing circuits comprising an input terminal, a plurality of control terminals, and a plurality of output terminals; one of the source signal output terminals connects the input terminal of the multiplexing circuit; the plurality of the control terminals of the multiplexing circuits receive the plurality of the control signals separately; and the plurality of the output terminals of the multiplexing circuits connect the plurality of the pixels on the pixel-array separately.

5. The driving circuit of claim 4, wherein the amount of the plurality of the control terminals is N and the amount of the plurality of output terminals is B, the value range of B is greater than N and is less than or equal to 2 of the N power.

6. The driving circuit of claim 4, wherein the amount of the plurality of the control terminals is N and the amount of the plurality of output terminals is B, the multiplexing circuit further comprising B transistor-columns, each transistor-column comprising N transistors; and
wherein the gates of the N transistors in each column connect to the N control terminals respectively, and the sources and the drains of the N transistors connect the input terminals and the output terminals respectively.

7. The driving circuit of claim 6, wherein each of said multiplexing circuits comprising an input terminal, three control terminals, six output terminals and six transistor columns; each the column of transistors comprising three transistors, denoted as a first transistor, a second transistor and a third transistor respectively; the plurality of control signals comprising a first control signal, a second control signal and a third control signal; and
wherein the gates of the three transistors of each the transistor-column connect three control terminals respectively to correspondingly receive the first control signal, the second control signal and the third control signal; wherein the drain of the first transistor connects the input terminal to receive one of the source driving signals, the source of the first transistor connects the drain of the second transistor, the source of the second transistor connects the drain of the third transistor, and the source of the third transistor connects one of the output terminals to transmit the source driving signal to the pixels corresponding to the output terminals.

8. The driving circuit of claim 7, wherein the first transistor, the second transistor and the third transistor of the first transistor-column are NMOS transistors, NMOS transistors, PMOS transistors; the first transistor, the second transistor and the third transistor of the second transistor-column are NMOS transistors, PMOS transistors, NMOS transistors; the first transistor, the second transistor and the third transistor of the third transistor-column are NMOS transistors, PMOS transistors, PMOS transistors; the first transistor, the second transistor and the third transistor of the fourth transistor-column are PMOS transistors, NMOS transistors, NMOS transistors; the first transistor, the second transistor and the third transistor of the fifth transistor-column are PMOS transistors, NMOS transistors, PMOS transistors; and the first transistor, the second transistor and the third transistor of the sixth transistor-column are PMOS transistors, PMOS transistors, NMOS transistors.

9. The driving circuit of claim 8, wherein, in a scan cycle, the first control signal, the second control signal, and the third control signal time-divisionally turn on to control the six transistor-columns, so one of the source driving signals transmit in time-division to the six pixels corresponding to the one of the source driving signals; wherein the first control signal is in a low voltage level, a low voltage level, a low voltage level, a high voltage level, a high voltage level, and a high voltage level in time-division; the second control signal is in a low voltage level, a high voltage level, a high voltage level, a low voltage level, a low voltage level, and a high voltage level in time-division; and the third control signal is in a high voltage level, a low voltage level, a high voltage level, a low voltage level, a high voltage level, and a low voltage level in time-division.

10. The driving circuit of claim 3, wherein the pixel array comprises a plurality of pixel-rows arranged in a column direction, each pixel row comprises the plurality of pixels with different colors arranged cyclically in a row direction.

11. The driving circuit of claim 10, wherein each of said pixel rows comprising a plurality of pixels arranged cyclically in accordance with red pixels, green pixels, and blue pixels in a row direction.

12. A LCD panel, comprising
a driving circuit and a pixel-array arranged in a matrix;
wherein the driving circuit comprises a source driving chip and a plurality of multiplexing circuits;
wherein the source driving chip is used to provide a plurality of source driving signals, each of the multiplexing circuits used to receive one of the source driving signals and a plurality of control signals, and the multiplexing circuit controlled by the control signals to transmit one of the multiple source driving signals in time-division into a plurality of pixels corresponding to one of the source driving signals;
wherein the amount of the control signals is less than the amount of the pixels corresponding to the one of the source driving signals.

13. The LCD panel of claim 12, wherein the source driving chip comprises a plurality of source signal output terminals; each of the multiplexing circuits comprising an input terminal, a plurality of control terminals, and a plurality of output terminals; one of the source signal output terminals connects the input terminal of the multiplexing circuit; the plurality of the control terminals of the multiplexing circuits receive the plurality of the control signals separately; and the plurality of the output terminals of the multiplexing circuits connect the plurality of the pixels on the pixel-array separately.

14. The LCD panel of claim 13, wherein the amount of the plurality of the control terminals is N and the amount of the plurality of output terminals is B, the value range of B is greater than N and is less than or equal to 2 of the N power.

15. The LCD panel of claim 13, wherein the amount of the plurality of the control terminals is N and the amount of the plurality of output terminals is B, the multiplexing circuit further comprising B transistor-columns, each transistor-column comprising N transistors; and
wherein the gates of the N transistors in each column connect to the N control terminals respectively, and the sources and the drains of the N transistors connect the input terminals and the output terminals respectively.

16. The LCD panel of claim 15, wherein each of said multiplexing circuits comprising an input terminal, three control terminals, six output terminals and six transistor columns; each the column of transistors comprising three transistors, denoted as a first transistor, a second transistor and a third transistor respectively; the plurality of control signals comprising a first control signal, a second control signal and a third control signal; and
wherein the gates of the three transistors of each the transistor-column connect three control terminals respectively to correspondingly receive the first control signal, the second control signal and the third control signal; wherein the drain of the first transistor connects the input terminal to receive one of the source driving signals, the source of the first transistor connecting the drain of the second transistor, the source of the second transistor connects the drain of the third transistor, and the source of the third transistor connects one of the output terminals to transmit the source driving signal to the pixels corresponding to the output terminals.

17. The LCD panel of claim 16, wherein the first transistor, the second transistor and the third transistor of the first transistor-column are NMOS transistors, NMOS transistors, PMOS transistors; the first transistor, the second transistor and the third transistor of the second transistor-column are NMOS transistors, PMOS transistors, NMOS transistors;
the first transistor, the second transistor and the third transistor of the third transistor-column are NMOS transistors, PMOS transistors, PMOS transistors; the first transistor, the second transistor and the third transistor of the fourth transistor-column are PMOS transistors, NMOS transistors, NMOS transistors; the first transistor, the second transistor and the third transistor of the fifth transistor-column are PMOS transistors, NMOS transistors, PMOS transistors; and the first transistor, the second transistor and the third transistor of the sixth transistor-column are PMOS transistors, PMOS transistors, NMOS transistors.

18. The LCD panel of claim 17, wherein in a scan cycle, the first control signal, the second control signal, and the third control signal time-divisionally turn on to control the six transistor-columns, so one of the source driving signals transmit time-divisionally to the six pixels corresponding to the one of the source driving signals; wherein the first control signal is in a low voltage level, a low voltage level, a low voltage level, a high voltage level, a high voltage level, and a high voltage level in time-division; the second control signal is in a low voltage level, a high voltage level, a high voltage level, a low voltage level, a low voltage level, and a high voltage level in time-division; and the third control signal is in a high voltage level, a low voltage level, a high voltage level, a low voltage level, a high voltage level, and a low voltage level in time-division.

19. The LCD panel of claim 12, wherein the pixel array comprises a plurality of pixel-rows arranged in a column direction, each pixel row comprises the plurality of pixels with different colors arranged cyclically in a row direction.

20. The LCD panel of claim 19, wherein each of said pixel rows comprising a plurality of pixels arranged cyclically in accordance with red pixels, green pixels, and blue pixels in a row direction.
